(19) United States
(12) Patent Application Publication
(10) Pub. No.: US 2003/0013808 A1
(43) Pub. Date: Jan. 16, 2003

(54) Foam control compositions

(76) Inventors: Lauren Marie Tonge, Sanford, MI (US); Hideki Kidera, Kanagawa Prefecture (JP); Rei Okada, Kanagawa Prefecture (JP); Tomohiro Noro, Kanagawa Prefecture (JP); Bernadette Soo Harkness, Vancouver (CA)

Correspondence Address: Dow Corning Coproration, Intellectual Property Dept. - CO1232, P.O. Box 994, Midland, MI, 48686-0994, US

(21) Appl. No.: 09/867,083

(22) Filed: May 29, 2001

Related U.S. Application Data
(63) Continuation of application No. 08/362,639, filed on Dec. 22, 1994, now abandoned.

(30) Foreign Application Priority Data
Dec. 28, 1993 (JP) 05/349347

(51) Int. Cl. C08L 83/04

(52) U.S. Cl. 525/100

(57) ABSTRACT

The present invention relates to a foam control composition and to its use in foaming systems. More particularly, this invention relates to a foam control composition comprising a silicone antifoam agent and a cross-linked organopolysiloxane polymer having at least one polyoxyalkylene group. The compositions of this invention exhibit excellent initial antifoam effect and dispersion stability.

### CROSS-REFERENCE TO RELATED APPLICATIONS

This is a continuation of U.S. patent application Ser. No. 08/362,639, filed on Dec. 22, 1994, which is now pending.

### BACKGROUND OF THE INVENTION

The present invention relates to a foam control composition and to its use in foaming systems. More particularly, this invention relates to a foam control composition comprising a silicone antifoam agent and a cross-linked organopolysiloxane polymer having at least one polyoxyalkylene group. The compositions of this invention exhibit excellent initial antifoam effect and dispersion stability.

A defoamer or antifoam agent is a material which, when added in low concentration to a foaming liquid controls the foam problem. Such materials, in addition, remove unsightly and troublesome surface foam and improve the filtration, watering, washing, and drainage of various types of suspensions, mixtures, and slurries. Defoamers have found application traditionally in such areas of use as the pulp and paper industry, paints and latex, coating processes, fertilizers, textiles, fermentation processes, metal working, adhesive, caulk and polymer manufacture, the sugar beet industry, oil well cement, cleaning compounds, detergents, cooling towers, and in chemical processes of varied description such as municipal and industrial primary and secondary waste water treatment.

It is essential for a defoamer that it be inert and not capable of reacting with the product or system in which it is used, and that it have no adverse effect on the product or system. A silicone antifoam agent is favorable, because it is chemically stable, rarely affects the treatment process, and exhibits a relatively high antifoam effect even in small amounts.

The use of various silicone containing compositions as antifoams or defoamers is known. In this regard, it is well established that this art is highly unpredictable and slight modifications can greatly alter the performance of such compositions. Most of the compositions contain silicone fluid (usually dimethylpolysiloxane), often in combination with small amount of silica filler. Many silicone foam control agents are known to suppress foam.

For example, Sullivan, in U.S. Pat. No. 3,383,327, discloses an antifoam agent prepared from a polydiorganosiloxane fluid, silica, and a hydroxylated polydimethylsiloxane. Rauner, in U.S. Pat. No. 3,455,839, discloses an aqueous defoaming composition consisting essentially of a polydimethylsiloxane fluid, a resin composed of (CH₃)₃SiO_{1/2} units and SiO₂ units and a silica aerogel.

Raleigh et al., in U.S. Pat. No. 4,012,334, disclose an antifoam composition comprising a dimethylpolysiloxane and a precipitated silica reacted with hexamethyldisilazane and a process for the preparation and use thereof. Edward, in U.S. Pat. No. 4,145,308, discloses foam suppressant compositions, useful in both aqueous and hydrocarbon liquids, consisting essentially of a polydimethylsiloxane, a silicone resin comprised of R₃SiO_{1/2} units and SiO₂ units wherein R is a monovalent hydrocarbon radical, and fumed or precipitated silica.

Maloney et al., in U.S. Pat. No. 4,443,357, disclose a foam controlling composition consisting essentially of an organopolysiloxane having at least one terminal alkoxy or hydroxy group, an organic silicone compound having the general formula R₂SiZ₂ wherein R is a monovalent hydrocarbon group and Z is a hydrolyzable group containing nitrogen, and silica. Pape et al., in U.S. Pat. No. 4,486,336, disclose foam suppressant compositions consisting essentially of a low viscosity polydimethylsiloxane, a high viscosity polydimethylsiloxane, a silicone resin comprising (CH₃)₃SiO_{1/2} units and SiO₂ units, and silica.

Aizawa et al., in U.S. Pat. Nos. 4,639,489 and 4,749,740 teach a method for producing a silicone defoamer composition wherein a complex mixture of polyorganosiloxanes, filler, a resinous siloxane, and a catalyst, to promote the reaction of the other components, are heated together at 50° C. to 300° C.

Hydrophobed silica/polydimethylsiloxane antifoams are also reviewed in DEFOAMING: Theory and Industrial Applications; Garrett, P. R., Ed.; Surfactant Science Series 45; Marcel Dekker: New York, 1993, especially pages 246-249.

Additionally, these silicone antifoam agents may include various surfactants and dispersing agents in order in impart improved foam control or stability properties to the compositions. Thus, for example, Rosen, in U.S. Pat. No. 4,076,648, teaches self-dispersible antifoam compositions consisting essentially of a lipophilic nonionic surface-active agent homogeneously dispersed in a non-emulsified diorganopolysiloxane antifoam agent. This combination is said to promote dispersability in water without the need for emulsification.

Keil, in U.S. Pat. No. 3,984,347, discloses a composition for controlling foam which comprises (1) a base oil of polyoxypropylene polymers, polyoxypropylene-polyoxyethylene copolymers or siloxane glycol copolymers, (2) an antifoam agent comprising a liquid polydimethylsiloxane, silica, and optionally a siloxane resin and (3) a siloxane copolymer dispersing agent. This composition enables the introduction of a diluted antifoam agent without having to make a water based emulsion.

McGee et al. in European Patent Application No.341,952 disclose a foam control composition comprising (1) a silicone defoamer reaction product and (II) a silicone glycol copolymer, is disclosed as being particularly effective in defoaming highly acidic or highly basic aqueous systems. However, when a foam control composition comprising a silicone antifoam agent and a silicone glycol copolymer is employed it is added in the form of a liquid or after dilution with water to a foamable liquid thus requiring higher levels of the silicone copolymer.

### BRIEF SUMMARY OF THE INVENTION

The present invention relates to a foam control composition comprising a silicone antifoam agent and a cross-linked organopolysiloxane polymer having at least one polyoxyalkylene group.

It is an object of this invention to provide foam control compositions which exhibit excellent initial antifoam effect and superior dispersion stability.

It is also an object of this invention to provide foam control compositions which exhibit persistent antifoam effect.

An additional object of this invention is to provide foam control compositions which provide excellent dispersion stability in both diluents and in concentrated surfactant solutions.

These and other features, objects and advantages of the present invention will be apparent upon consideration of the following detailed description of the invention.

### BRIEF DESCRIPTION OF THE SEVERAL VIEWS OF THE DRAWING

The above and the objects of the invention will be seen by reference to the detailed description of the invention taken in connection with the accompanying drawing, in which:

FIG. 1 is an elevational view of the device employed for testing the foam control compositions of the present invention.

### DETAILED DESCRIPTION OF THE INVENTION

The present invention relates to a foam control composition comprising: (I) a silicone antifoam agent and (II) a cross-linked organopolysiloxane polymer having at least one polyoxyalkylene group.

The compounds or compositions employed as the silicone antifoam agent herein can be alkylated polysiloxane compounds of several types, and can be used alone, or in combination with various solid materials such as silica aerogels, xerogels, or hydrophobic silicas of various types. In industrial practice, the term “silicone” has become a generic term which encompasses a variety of relatively high molecular weight polymers containing siloxane units and hydrocarbon groups of various types. In general terms, the silicone antifoam agent can be siloxanes having the unit formula:

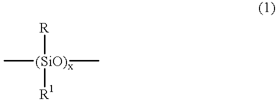

wherein x has a value ranging from about 20 to about 2,000, and R and R¹ are independently selected from the group consisting of alkyl and aryl groups. Preferred alkyl groups include methyl, ethyl, propyl, and butyl, and preferred aryl groups include phenyl. Polydimethylsiloxanes (where R and R¹ are both methyl) having a molecular weight within the range of from about 2,000 to about 200,000, or higher, are all useful as antifoam agents in the present invention. Such silicone compounds are commercially available from Dow Coming Corporation under the trade name Dow Coming 200® Fluid.

Additionally, other silicone compounds where the side chain groups, R and R¹ are independently selected from the group consisting of alkyl, aryl, or mixtures of alkyl and aryl groups exhibit useful foam controlling properties. These compounds are readily prepared by the hydrolysis of the appropriate alkyl, aryl or mixtures of alkylaryl silicone dichlorides with water in a manner well known in the art. Specific examples of such silicone antifoam agents useful as (I) include diethyl polysiloxanes, dipropyl polysiloxanes, dibutyl polysiloxanes, methylethyl polysiloxanes, and phenylmethyl polysiloxanes. Dimethyl polysiloxanes are particularly useful herein due to their low cost and ready availability.

A second type of silicone antifoam agent useful as (I) comprises (i) silicone and (ii) silica and can be prepared by admixing a silicone fluid of the type described hereinabove with a hydrophobic silica. Any of several known methods may be used for making a hydrophobic silica which can be employed herein in combination with a silicone fluid as the antifoam agent. For example, a fumed silica can be reacted with a trialkyl chlorosilane (i.e. “silanated”) to affix hydrophobic trialkylsilane groups on the surface of the silica. Silicas having organosilyl groups on the surface thereof are well known and can be prepared in many ways such as by contacting the surface of a fumed or precipitated silica or silica aerogel with reactive silanes such as chlorosilanes or alkoxysilanes or with silanols or siloxanols or by reacting the silica with silanes or siloxanes. Various grades of silica having a particle size of several millimicrons to several microns and a specific surface area of about 500 to 50 m²/g are commercially available and several hydrophobic silicas having different surface treatments are also commercially available.

The silicone antifoam agent (I) can also be any of the silicone antifoam agents known in the art such as those disclosed in U.S. Pat. Nos. 3,383,327, 3,455,839, 4,012,334, 4,145,308, 4,443,357, 4,486,336, 4,639,489, 4,749,740, 4,076,648, and 3,984,347 incorporated herein by reference to teach silicone antifoam agents which are suitable, and those skilled in the art are also directed to European Patent Application Nos. 341,952 and 217,501 which also disclose silicone antifoam agents suitable as component (I). In the above-cited references which disclose antifoam agents suitable for use in the present invention, the silica present in the antifoam compounds/compositions is hydrophobed in-situ. This list is not intended as a restriction on the type of silicone antifoam agent which can be employed in the foam control compositions of this invention but is disclosed to exemplify the silicone antifoam agents suitable for use in the compositions of this instant invention.

Thus the silicone antifoam agent (I) can be a reaction product prepared by reacting at a temperature of 50° C. to 300° C.: (i) 100 parts by weight of at least one polyorganosiloxane selected from the group consisting of (A) a polyorganosiloxane having a viscosity of about 20 to 100,000 mm²/s at 25° C. and being expressed by the general formula R²ₐSiO_{(4-a)/2} in which R² is a monovalent hydrocarbon or halogenated hydrocarbon group having 1 to 10 carbon atoms and a has an average value of 1.9 to 2.2 and (B) a polyorganosiloxane having a viscosity of 200 to about 100 million mm²/s at 25° C. expressed by the general formula R³_{b}(R⁴O)_{c}SiO_{(4-b-c)/2} in which R³ is a monovalent hydrocarbon or halogenated hydrocarbon group having 1 to 10 carbon atoms, R⁴ is hydrogen or a monovalent hydrocarbon group having 1 to 10 carbon atoms, b has an average value of 1.9 to 2.2 and c has a sufficiently large value to give at least one —OR⁴ group in each molecule, at least one such —OR⁴ group being present at the end of the molecular chain; (ii) 0.5 to 20 parts by weight of at least one resinous silicon compound selected from the group consisting of (a) an organosilicon compound of the general formula R⁵_{d}SiX_{4-d} in which R⁵ is a monovalent hydrocarbon group having 1 to 5 carbon atoms, X is a hydrolyzable group and d has an average value of one or less, (b) a partially hydrolyzed condensate of said compound (a), (c) a siloxane resin consisting essentially of (CH₃)₃SiO_{1/2} units and SiO_{4/2} units wherein the ratio of (CH₃)₃SiO_{1/2} units to SiO_{4/2} units is 0.4:1 to 1.2:1, and (d) a condensate of said compound (c) with said compound (a) or (b); (iii) up to 30 parts by weight of a finely divided filler; and (iv) a catalytic amount of a compound for promoting the reaction of components (i) to (iii). For a more detailed explanation of the above-prepared reaction product one skilled in the art is directed to U.S. Pat. Nos. 4,639,489 and 4,749,740.

The silicone antifoam agent (I) can also be a composition comprising the reaction product prepared as described hereinabove and from about 20 to 200 parts by weight for each 100 parts by weight of said reaction product (i) of a silicone-glycol copolymer having its formula selected from

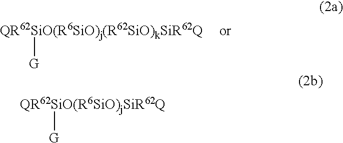

wherein R⁶ is a monovalent hydrocarbon or halogenated hydrocarbon group, Q is R⁶ or G, j has a value of 1 to 150, k has a value of 1 to 400 and G is a polyoxyalkylene group having its formula selected from the group consisting of

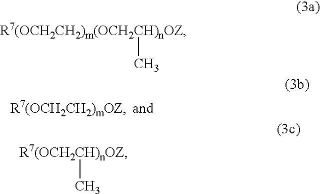

wherein R⁷ is a divalent hydrocarbon group having 1 to 20 carbon atoms, m has an average value of about 1 to 50, n has an average value of 1 to about 50 and Z is selected from the group consisting of hydrogen, an alkyl radical having 1 to 6 carbon atoms and an acyl group having 2 to 6 carbon atoms, said silicone glycol being dispersible in water.

Monovalent hydrocarbon groups suitable as R⁶ include alkyl radicals, such as methyl, ethyl, propyl, butyl, hexyl, octyl, and decyl; cycloaliphatic groups, such as cyclohexyl; aryl groups such as phenyl, tolyl, and xylyl; arylalkyl groups such as benzyl and phenylethyl. Highly preferred monovalent hydrocarbon groups are methyl and phenyl. Monovalent halogenated hydrocarbon groups include any monovalent hydrocarbon radical noted above and has at least one of its hydrogen atoms replaced with a halogen, such as fluorine, chlorine, or bromine. The group R⁷ hereinabove is a divalent hydrocarbon group having from 1 to 20 carbon atoms which is exemplified by groups such as alkylene radicals including methylene, ethylene, propylene, butylene, phenylene, trimethylene, 2-methyltrimethylene, pentamethylene, hexamethylene, 3-ethyl-hexamethylene, octamethylene, —CH₂(CH₃)CH—, —CH₂CH(CH₃)CH₂—, and —(CH₂)₁₈—, cycloalkylene radicals such as cyclohexylene, arylene radicals such as phenylene, combinations of divalent hydrocarbon radicals such as benzylene (—C₆H₄CH₂—), hydroxylated hydrocarbon residues, chloroethylene, fluoroethylene, —CH₂CH₂CH₂OCH₂—, —CH₂CH₂OCH₂CH₂—, —CH₂CH₂OCH(CH₃)CH₂—, and —CH₂OCH₂CH₂OCH₂CH₂—. A more detailed description of the above composition can be found in European Patent Application No. 341,952. It is preferred that both Q and R⁶ of component (II) are methyl radicals and that R⁷ is the trimethylene group. It is further preferred that j is between 1 and 10, k is between 0 and 100 and m is between 7 and 12. The silicone glycols are well known in the art, many of these being available commercially, and further description thereof is considered unnecessary.

Component (II) of the foam control compositions of this invention is a cross-linked organopolysiloxane polymer having at least one polyoxyalkylene group. This class of compounds have been generally described by Bahr et.al. in U.S. Pat. Nos. 4,853,474 and 5,136,068, incorporated herein by reference to teach cross-linked organopolysiloxane polymers suitable as (II). Compounds suitable as (II) include organopolysiloxane-polyoxyalkylene polymer molecules which are intentionally cross-linked through a cross-linking agent joined thereto by nonhydrolyzable bonds and being free of internal hydrolyzable bonds.

Component (II) may be obtained by a method comprising preparing a cross-linked organopolysiloxane polymer and combining a polyoxyalkylene group therewith or by a method comprising preparing a linear polyorganosiloxane having a polyoxyalkylene group combined therewith and cross-linking the same.

The cross-linking in this system can be attained through a variety of mechanisms. Those skilled in the art will readily recognize the systems wherein the required components are mutually compatible to carry out the method of preparing component (II). By way of illustration, an extensive bibliography of siloxane polymer chemistry is provided in Siloxane Polymers, S. J. Clarson and J. A. Semlyen eds., PTR Prentice Hall, Englewood Cliffs, N.J., (1993).

Not to construed as limiting this invention, it is preferred that the cross-linking bonds and the bonds to the organopolysiloxane-polyoxyalkylene molecules are not hydrolyzable, and that the cross-linking bridge contains no hydrolyzable bonds. It is recognized that similar emulsifiers wherein the polyoxyalkylene units are attached to the organopolysiloxane units via SiOC bonds are useful in applications not requiring extended stability under conditions where hydrolysis may occur. It is further recognized that such emulsifiers containing cross-links formed by SiOC bonds offer benefits of improved emulsion stability and consistency in such applications not requiring extended stability under conditions where hydrolysis may occur.

Preferably, the cross-linked siloxane polymer (II) is obtained by the addition reaction between the following components: (i) an organopolysiloxane having an Si—H group at each of its terminals and an organopolysiloxane having at least two allyl groups in the side chains of each molecules thereof, or (ii) more preferably, an organopolysiloxane having at least two Si—H groups in the side chains of each molecule thereof, and a polyorganopolysiloxane having each of its terminals blocked with an allyl group or a silanol group.

The preferred cross-linking radical is a vinyl-terminated organosiloxane used in combination with an Si—H containing backbone. This organosiloxane bridge should not contain any reactive sites for the polyoxyalkylene moieties. An organosiloxane bridge cooperates with the siloxane backbones which it bridges to create a siloxane network at the interface of water and the silicone antifoam agent. This network is thought to be important in effecting the stabilizing properties and characteristics of the present invention. The siloxane bridge works with other types of antifoams. Other bridge types may be more suitable for non-silicone antifoams (e.g. an alkane bridge for mineral oil based antifoams).

The cross-linked organopolysiloxane polymer to be used as (II) should be one that satisfies the following conditions: (1) it has a three-dimensional crosslinked structure, (2) it has at least one polyoxyalkylene group, and (3) it has fluidity (i.e. it is “free flowing”). The term “three-dimensional cross-linked structure” used herein denotes a structure in which at least two organopolysiloxane molecules are bonded together through at least one bridge.

The exact number of organopolysiloxane-polyoxyalkylene polymer molecules which will be bridged together will vary within each compound. One limitation on such cross-linking is that the overall molecular weight must not become so great as to cause the material to gel. The extent of cross-linking must thus also be regulated relative to the molecular weight of each individual polymer molecule being cross-linked since the overall molecular weight must also be maintained sufficiently low to avoid gelling. In controlling the cross-linking reaction there is also the possibility that some un-cross linked material will be present.

In the present invention, it is preferred that component (II) is a compound having a viscosity of 100 to 100,000 mm²/s at 25° C. and having the unit formula:

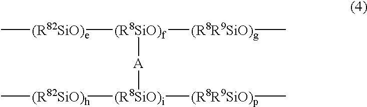

wherein R⁸ is a monovalent hydrocarbon group, A is a group having its formula selected from (CH₂)_{q}—(R¹⁰₂SiO)ᵣSi(CH₂)ₛ or O(R¹⁰₂SiO)ᵣ—SiO wherein R¹⁰ denotes a monovalent hydrocarbon group, q has a value of 2 to 10, r has a value of 1 to 5000, s has a value of 2 to 10, R⁹ denotes a group having its formula selected from the group consisting of:

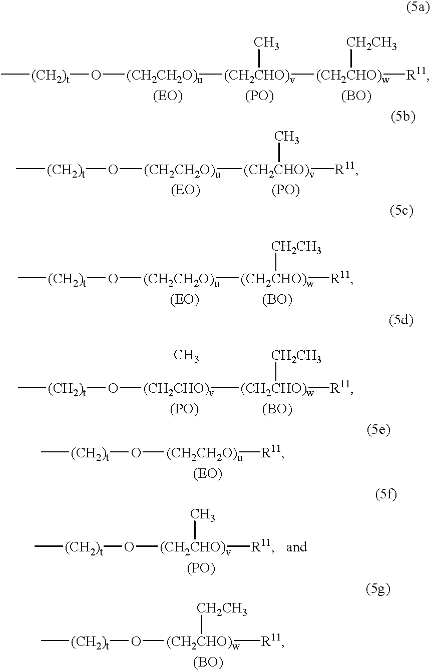

wherein R¹¹ is selected from a hydrogen atom, an alkyl group, an aryl group, or an acyl group, t has a value of 0 to 6, u has a value of from greater than zero to 150, v has a value of from greater than zero to 150, and w has a value of from greater than zero to 150, e has a value of 1 to 1000, f has a value of from greater than zero to 30, g has a value of 1 to 1000, h has a value of 1 to 1000, i has a value of from greater than zero to 30, p has a value of 1 to 1000. In the formula hereinabove EO, PO, and BO denote ethylene oxide, propylene oxide, and butylene oxide groups, respectively. The groups R⁸ and R¹⁰ can be the same or different as desired and are preferably alkyl groups or aryl groups and it is highly preferred that they are both methyl.

In the formulae hereinabove, it is preferred that e has a value of 1 to 500 and it is highly preferred that e has a value of 1 to 250, it is preferred that f has a value of from greater than zero to 20 and it is highly preferred that f has a value of from 1 to 15, it is preferred that g has a value of 1 to 100 and it is highly preferred that g has a value of 1 to 50, it is preferred that h has a value of 1 to 500 and it is highly preferred that h has a value of 1 to 250, it is preferred that i has a value of from greater than zero to 20 and it is highly preferred that i has a value of from greater than 1 to 15, it is preferred that p has a value of 1 to 100 and it is highly preferred that p has a value of 1 to 50, it is preferred that q has a value of 2 to 6, it is preferred that r has a value of 1 to 2500 and it is highly preferred that r has a value of 20 to 1000, it is preferred that s has a value of 2 to 6, it is preferred that t has a value of 0 to 3, it is preferred that u has a value of from 1 to 100 and it is highly preferred that u has a value of 5 to 50, it is preferred that v has a value of from 1 to 100 and it is highly preferred that v has a value of 5 to 50, it is preferred that w has a value of from 1 to 100 and it is highly preferred that w has a value of 1 to 50. It is preferred that the cross-linked organopolysiloxane polymer of component (II) is triorganosiloxy endblocked at each terminal of the polymer, and it is highly preferred that the polymer is trimethylsiloxy endblocked at each terminal of the cross-linked polymer.

A specific example of the method for producing the crosslinked organopolysiloxane polymers will now be described. Preparation of a crosslinked organopolysiloxane polymer was done through the following steps: (I) a charging step in which a linear polysiloxane having hydrogen atoms in its side chains, a polysiloxane having vinyl groups and a catalyst for promoting the reaction, particularly platinum catalysts such as an isopropanol solution of H₂PtCl₆6H₂O with a 2% methanol solution of sodium acetate are put in a reactor, (II) an agitation/heating step in which agitation is conducted, for example, at 40° C. for 30 minutes, (III) an input step in which a polyoxyalkylene and a solvent (isopropanol) are put in the reactor, (IV) a reflux step in which the isopropanol is refluxed, for example, at 80° C. for 1.5 to 2 hours while monitoring the reaction rate of Si—H, (V) a stripping step in which the isopropanol is stripped, for example, at 130° C. under a reduced pressure of 25 mmHg, and (VI) a final step in which the reduced pressure condition of step (V) is released and the reaction mixture is cooled to 60° C. to obtain a final product.

An example of a linear polysiloxane having hydrogen atoms in its side chains suitable for step (I) is a polysiloxane having its formula selected from:

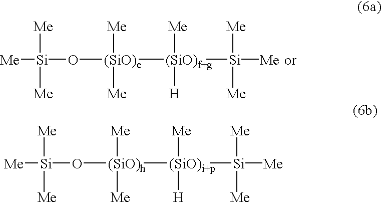

wherein Me hereinafter denotes methyl and e, f, g, h, i, and p are as defined above. An example of a polysiloxane having vinyl groups suitable for step (I) is a polysiloxane having the formula:

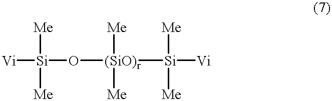

wherein Me denotes methyl, Vi hereinafter denotes vinyl, and r is as defined above. The reaction of these two compounds in step (II) results in a cross-linked siloxane polymer having the formula

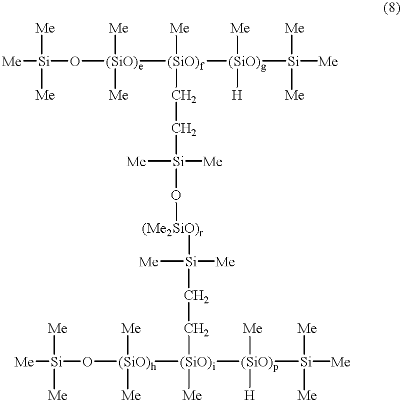

Introduction of a polyoxyalkylene group into the obtained crosslinked organopolysiloxane polymer (steps III-VI) is accomplished by reacting the crosslinked polymer with a polyoxyalkylene compound having its formula selected from the group consisting of

Vi—CH₂—O—(EO)ᵤ—(PO)ᵥ—(BO)_{w}—H (9a)

Vi—CH₂—O—(EO)ᵤ—(PO)ᵥ—H, (9b)

Vi—CH₂—O—(EO)ᵤ—(BO)_{w}—H, (9c)

Vi—CH₂—O—(PO)ᵥ—(BO)_{w}—H, (9d)

Vi—CH₂—O—(EO)ᵤ—H, (9e)

Vi—CH₂—O—(BO)_{w}—H, and (9f)

Vi—CH₂—O—(PO)ᵥ—H, (9g)

wherein Vi, EO, PO, and BO are as denoted hereinabove, and u, v, and w are as defined above. The resulting compound was a cross-linked organopolysiloxane polymer having the formula

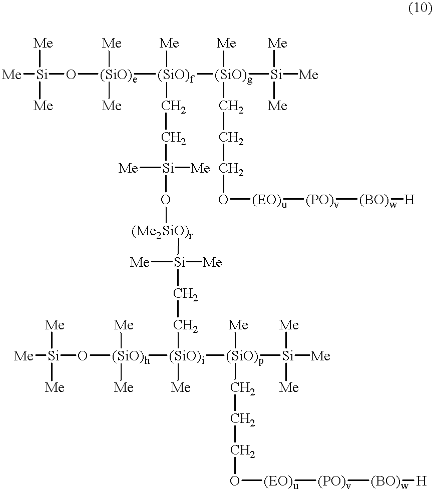

wherein Me, EO, PO, BO, e, f, g, h, i, p, and r are as defined hereinabove, u has a value of 0 to 150, v has a value of 0 to 150, and w has a value of 0 to 150, with the proviso that the value of u+v+w is at least one.

The foam control compositions of the present invention can be produced by mixing 100 parts by weight of silicone antifoam agent (I) with 0.1 to 1900 parts by weight of cross-linked organopolysiloxane polymer (II).

More specifically, the foam control compositions of this invention can be produced by a method in which cross-linked organopolysiloxane polymer (II) is added as is or after dilution with an appropriate solvent or water to the silicone antifoam agent (I) and then a homogeneous dissolution or dispersion is carried out. Alternatively, the composition can be produced by a method in which component (II) is added at an appropriate time in the step of producing the foam control composition. These methods are not critical and any other appropriate ones may also be utilized.

The foam control compositions of the present invention may contain other components on an optional basis insofar as the object of the present invention is not impaired, for example, inorganic fillers such as quartz, biocides when water is present, silica including hydrophobically treated silicas, metal hydroxide micropowders such as aluminum hydroxide micropowder, calcium hydroxide micropowder, and magnesium hydroxide micropowder, bis amides such as those disclosed in U.S. Pat. No. 5,192,336 incorporated herein by reference to disclose amides suitable for addition to the foam control compositions of the present invention, flake-form fillers such as mica, dimethylpolysiloxanes, epoxy-functional diorganopolysiloxanes, and amino-functional diorganopolysiloxanes, as well as pigments, corrosion inhibitors, and dyes.

The foam control compositions of the present invention is added as it is in the form of a liquid or after dilution with water or another appropriate solvent to a foamable liquid. The foamable liquid may be a concentrate or be present at end-use levels. The compositions of the present invention can be used as any kind of foam control agents, i.e. as defoaming agents and/or antifoam agents. Defoaming agents are generally considered as foam reducers whereas antifoam agents are generally considered as foam preventors. The compositions of the present invention find utility as foam control compositions in various media or foamable liquids such as inks, coatings, paints, detergents (i.e. compositions which contain surfactants with or without detergency builders) such as liquid detergents, heavy duty liquid detergents and textile scours, black liquor, and pulp and paper manufacture.

Various solvents or diluents are available, such as nonaqueous liquid continuous phases, which are preferably selected from the group consisting of ethylene glycol, propylene glycol, polypropylene glycol, polyethylene glycol, copolymers of ethylene and propylene glycols, condensates of polypropylene glycol with polyols, condensates of polyethylene glycol with polyols, condensates of copolymers of ethylene and propylene glycols with polyols, alcohol alkoxylates, and alkylphenol alkoxylates. The nonaqueous phase is selected for ease of dispersability and solubility in the foamable liquid. Poor solubility in the foamable liquid can lead to poor stability and poor performance of the foam control composition.

From the tables and examples below, it is apparent that the foam control compositions of the present invention are excellent in not only the initial antifoam effect but also the persistence of the antifoam effect and excellent dispersion stability in both diluents and in concentrated surfactant solutions (i.e. no coalescence or aggregation was observed). If the foam control compositions are density matched to the media, phase stability (i.e. stability against sedimentation or creaming) is also maintained. All parts and percentages in the examples are on a weight basis and all measurements were made at 25° C. unless indicated to the contrary.

### EXAMPLES

The following materials, listed for ease of reference, were employed in the preparation of the foam control compositions:

### Component I=Silicone Antifoam (SA) Agents

SA1 was prepared according to the method of Aizawa U.S. Pat. No. 4,639,489 cited supra by mixing together the following materials: 378 g of polydimethylsiloxane having its terminals blocked with trimethylsilyl groups, 180 g of polydimethylsiloxane having its terminals blocked with hydroxyl groups and 18 g of ethyl polysilicate with heating and then adding 30 g of silica and 30 g of polydimethylsiloxane having its terminals blocked with hydroxyl groups to the mixture.

SA2 was a trimethylsilyl endblocked polydimethylsiloxane having a viscosity of 10,000 mm²/s of 25° C.

SA3 was a mixture of 100 parts by weight of a trimethylsilyl endblocked polydimethylsiloxane having a viscosity of 500 mm²/s at 25° C. and 5 parts by weight of wet-process silica.

SA4 was a blend of 95 parts of a trimethylsilyl endblocked polydimethylsiloxane having a viscosity of 10,000 mm²/s and 5 parts hydrophobic silica.

SA5 was an alkyl-modified silicone oil having a degree of polymerization ranging from 40 to 50 and having an alkyl group chain length of 12 carbon atoms.

SA6 was a mixture of paraffin oil and hydrophobic silica.

SA7 was prepared according to the method of John et al. as described in EP 0 217 501, by mixing together 64.3 part of a polydimethylsiloxane having its terminals blocked with trimethylsilyl groups, 3.43 parts of a silicone resin and 32 parts polydimethylsiloxane having its terminals blocked with hydroxyl groups with heating and then adding 5.27 parts of silica and 15.5 parts of quartz to the mixture.

SA8 was a blend of 95 parts of a trimethylsilyl endblocked polydimethylsiloxane having a viscosity of 12,500 mm²/s and 5 parts of SIPERNAT® D13 which is a hydrophobic silica from Degussa Corporation (Ridgefield Park, N.J.).

SA9 was prepared by mixing 88.8 parts of trimethylsilyl endblocked polydimethylsiloxane having a viscosity of 12,500 mm²/s, 8.8 parts of silica gel and 2.4 parts of activated hexamethyldisilazane.

SA10 was prepared by mixing 88.3 parts of trimethylsilyl endblocked polydimethylsiloxane having a viscosity of 1000 mm²/s, 2.2 parts of a resin and 9.5 parts of precipitated silica.

SA 11 was a blend of 95 parts of a trimethylsilyl endblocked polydimethylsiloxane having a viscosity of 1,000 mm²/s and 5 parts of CAB-O-SIL ™ TS-720 which is a hydrophobic silica from Cabot Corporation (Tuscola, Ill.).

### Component II=Crosslinked Organopolysiloxane Polymers (CP)

The starting materials used for producing the cross-linked organopolysiloxane polymers having at least one polyoxyalkylene group to be used in each of the following examples are as follows:

Component (A1): was a linear polysiloxane having the formula:

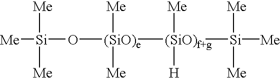

wherein e has a value in the range of 74 to 80, and f+g is in the range of 5 to 9.

Component (A2): was a linear polysiloxane having the formula:

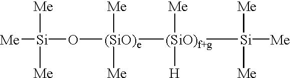

wherein e has a value of about 103 and f+g has a value of about 9.5.

Component (B1): was a polysiloxane having the formula

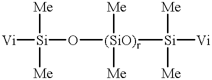

having a molecular weight ranging from 8000 to 15,000.

Component (B2): was a polysiloxane having the same formula as (B1) hereinabove except that B2 has a molecular weight in the range of 18,000 to 25,000.

Component (B3): was a polysiloxane having the formula —(MeViSiO)ᵣ— wherein r has a value in the range of 3 to 8.

Component (C1): was a polyoxyalkylene having the formula: Vi—CH₂—O—(EO)ᵤ—(PO)ᵥ—H having a molecular weight in the range of from 2000 to 3000 and the ratio of u:v is 1:1.

Component (C2) was a polyoxyalkylene having the same chemical formula as C1 except that C2 has a molecular weight of about 1900.

Component (D): was isopropanol (as a solvent).

Component (E): was a 2% methanol solution of sodium acetate; and

Component (F): was a 2% isopropanol solution of H₂PtCl₆.6H₂O.

Synthesis of cross-linked polymer CP1 was prepared by adding 64.4 grams (g) of (A1), 35.3 g of (B1), 0.47 g of (F), and 0.75 g of (E) in a reactor and the resulting mixture was agitated at 40° C. for 30 minutes. Next, 200.2 g of (C1) and 90 g of (D) were added to the reactor and the isopropanol was refluxed at 80° C. for 1.5 to 2 hours while monitoring the reaction rate of the Si—H. The resulting mixture was then stripped to remove the isopropanol at 130° C. under a reduced pressure of 25 mmHg. Next, the reaction mixture was cooled to 60° C. to obtain a final product.

The obtained crosslinked polymer CP1 was a compound represented by Chemical Formula (10) described hereinabove wherein e and h were 76, f and i were 0.58, g and p were 6.42, u was 24, and v was 24, w was zero, and having a crosslinked chain length of 140 to 150, a crosslinking ratio of 8.3 and a viscosity of 31,400 mPa·s (millipascal-seconds). As will be appreciated by those skilled in the art, the siloxane backbone and the polyoxyalkylene materials actually are mixtures and the average mean sizes are listed hereinabove.

The term “cross-linked chain length” used herein means the number of siloxane units in component (B), and this determines the value of r in Chemical Formula (10).

The term “cross-linking ratio” used herein means the ratio of the hydrogen atoms used for formation of cross-linkage to all of the hydrogen atoms of each molecule of component (A), which is expressed by the formula: f/(f+g)×100% or i/i+p×100% with respect to Chemical Formula (10) hereinabove.

Four types of crosslinked polymers, CP2 to CP5, were synthesized in the same manner as the one described above for cross-linked polymer CP1, except that the amount of components (A1), (B 1), and (C1) were varied as specified in the following Table I. The properties of each of the crosslinked polymers are also given in Table I. With respect to the items not given in the table, the same characteristics as those for CP1 apply.

TABLE I

| | | | | | |
|---|---|---|---|---|---|
| Component (g) (A1) | 64.4 | 64.9 | 65.4 | 65.9 | 66.5 |
| Component (g) (B1) | 35.3 | 30.5 | 26.9 | 21.7 | 16.8 |
| Component (g) (C1) | 200.2 | 204.4 | 207.7 | 212.3 | 216.7 |
| e,h | 76 | 76 | 76 | 76 | 76 |
| f,i | 0.58 | 0.50 | 0.44 | 0.35 | 0.27 |
| g,p | 6.42 | 6.50 | 6.56 | 6.65 | 6.73 |
| Crosslinked chain | 140- | 140- | 140- | 140- | 140- |
| length | 150 | 150 | 150 | 150 | 150 |
| Crosslinking ratio | 8.3 | 7.1 | 6.3 | 5.0 | 3.8 |
| Viscosity (mPa·s) | 31400 | 20200 | 14900 | 10750 | 7750 |

Three other types of cross-linked polymers, CP6 to CP8, were synthesized in the same manner as that described above for cross-linked polymer CP1, except that the type of components (A) and (B) were changed and the amounts of the components were varied as specified in Table II.

The properties of each of the cross-linked polymers are also given in Table II. With respect to the items not given in the Table, the same characteristics as those for CP1 apply.

A comparative siloxane polymer (CSP) was also synthesized in the same manner as described above, except that no component (B) was used resulting in a silicone glycol copolymer without a bridge, and the amounts of the other components were varied as specified in the following Table II. The properties thereof are also given in Table II. With respect to the items not given in the table, the same characteristics as those for CP1 apply.

TABLE II

| Cross linked siloxane | | CP6 | CP7 | CP8 | CSP |
|---|---|---|---|---|---|
| Component (A) | Type | A1 | A1 | A2 | A1 |
| | Amount | 62.7 | 72.2 | 107.1 | 65.4 |
| Component (B) | Type | B2 | B3 | B1 | — |
| | Amount | 33.1 | 0.5 | 42.8 | |
| Component (C) | Type | C1 | C1 | C2 | C1 |
| | Amount | 204.2 | 227.3 | 150 | 221.6 |
| e,h | | 76 | 76 | 103 | 76 |
| f,I | | 0.27 | 0.50 | .25 | — |
| g,p | | 6.73 | 6.50 | 9.25 | 7.00 |

| | | | | |
|---|---|---|---|---|
| Cross linked chain length | 420-430 | 3-5 | 140- | — |
| | | | 150 | |
| Cross linking Ratio | 3.8 | 7.1 | 2.6 | — |
| Viscosity (mPa·s) | 15000 | 7800 | 14600 | 3500 |

### Diluents

P15-200 ™ is a polyglycol copolymer from Dow Chemical Company (Midland, Mich.). UCON ™ 50HB260 and UCON ™ 50HB5100 are polyglycol copolymers from Union Carbide Chemicals and Plastics Company (Danbury, Conn.). Pluronic ™ L101 is a block copolymer of ethylene oxide and propylene oxide from BASF Corporation (Parsippany, N.J.).

Evaluation of antifoam performance

Two foamable water-base liquids were prepared by dissolving cellulose and lignin compounds in water in a total concentration of 0.4% by weight to obtain foamable liquid A, and in a total concentration of 2.0% by weight to obtain foamable liquid B.

Use was made of a testing device shown in FIG. 1. 300 g of the above foamable liquid A was introduced into a graduated glass cylinder (10) having an inner diameter of 50 mm, vertically erected in a thermostatic bath (20). This foamable liquid was circulated through a circulation pipe (30) in the direction of the arrow indicated in FIG. 1 at a temperature adjusted to 70° C.±1° C. and at a flow rate of 2.0 l per min by means of a disconnected magnetic pump (40), so that the foamable liquid continuously dropped from an outlet (35) of the circulation pipe (30) toward the surface of the liquid phase L in the glass cylinder (10) to thereby form a foaming condition in the glass cylinder (10).

This foaming was continued for 10 minutes, and then the foam control composition was added by the use of a micropipette in an amount such that the total amount of the first and second components was 5 ppm based on the foamable liquid.

After the addition of the foam control composition, and after the lapse of each given circulation time, the volume of a foam layer B (the surface thereof being indicated by the broken line) formed so as to stably remain on the liquid phase L in the glass cylinder (10) was measured by a scale on the glass cylinder (10). The initial antifoam effect and the persistence of the antifoam effect were evaluated on the basis of the measured volumes.

### Example 1

A foam control composition, hereinafter referred to as “Sample 1”, was prepared by slowly mixing together the following materials:

(1) 15 parts by weight of a first component composed of silicone antifoam agent SA1;

(2) 15 parts by weight of a second component comprised of cross-linked polymer CP3; and

(3) 70 parts by weight of water.

In order to test the dispersion stability, the Sample 1 was allowed to stand still at 25° C. As a result, it was confirmed that, even after the lapse of 72 hours, the same stable dispersion condition as that initially observed was maintained.

A comparative foam control composition, hereinafter referred to as the Comparative Sample 1, was prepared in the same manner as that described above, except that 13.65 parts by weight of CSP and 1.35 parts by weight of component (B1) were used instead of 15 parts by weight of the second component CP3.

In order to test the dispersion stability, the Comparative Sample 1 was allowed to stand still at 25° C. After 12 hours, the formation of an oily aggregate was observed.

The antifoam performance of Sample 1 and Comparative Sample 1 were tested in the manner described above using foamable liquid A. The results are shown in Table III.

TABLE III

| | | | Sample 1 | Comp. Sample 1 |
|---|---|---|---|---|
| Recipe of | 1st comp. | SA1 | 15 | 15 |
| Antifoam | 2nd | type | CP3 | CSP* |
| Composition | Comp. | amount | 15 | 15 |
| (wt %) | Water | | 70 | 70 |
| antifoam | Time | 0.0 | 250 | 250 |
| performance | (min) | 0.5 | 35 | 35 |
| Volume of | | 1.0 | 55 | 70 |
| Foam | | 3.0 | 85 | 125 |
| (ml) | | 5.0 | 125 | 155 |
| | | 10.0 | 190 | 220 |

*The second component of Comp. Sample 1 is a non-reacted mixture of CSP and an polyorganosiloxane having vinyl groups.

### Example 2

Foam control compositions, hereinafter referred to as Samples 2 to 8, were prepared in the same manner as that of Example 1, except that the amount of the first component SA1 was changed to 5% by weight, and that each of the CP1 to CP7 was used as the second component in an amount of 5% by weight.

A comparative foam control composition, hereinafter referred to as Comparative Sample 2, was prepared in the same manner as that of Example 1, except 5% by weight of CSP was used instead as the second component, and the amount of the first component, SA1, was changed to 5% by weight.

The antifoam performance of each of the above Samples 2 to 8 and Comparative Sample 2 was tested in the same manner as that of Example 1, except that use was made of the foamable liquid B. The results are shown in the following Table IV.

TABLE IV

| | | | Sample 2 | Sample 3 | Sample 4 | Sample 5 | Sample 6 | Sample 7 | Sample 8 | Comp. 2 |
|---|---|---|---|---|---|---|---|---|---|---|
| Recipe of | SA1 | | 5 | 5 | 5 | 5 | 5 | 5 | 5 | 5 |
| Composit- | Type | | CP1 | CP2 | CP3 | CP4 | CP5 | CP6 | CP7 | CSP* |
| ion | Amount | | 5 | 5 | 5 | 5 | 5 | 5 | 5 | 5 |
| (wt %) | Water | | 90 | 90 | 90 | 90 | 90 | 90 | 90 | 90 |
| Antifoam | Time | 0 | 300 | 300 | 300 | 300 | 300 | 300 | 300 | 300 |
| Perform. | (min.) | 0.5 | 77 | 79 | 80 | 98 | 100 | 90 | 100 | 130 |
| Foam Vol. | | 1.0 | | | | | | 85 | 80 | |
| (ml) | | 5.0 | 158 | 150 | 145 | 165 | 170 | 145 | 130 | 180 |

*The second component of Comp. Sample 2 is a non-reacted mixture of CSP and an polyorganosiloxane having vinyl groups.

### Example 3

Foam control compositions, hereinafter referred to as Samples 9 to 14, were prepared in the same manner as that of Example 1, except that SA1 and each of the following silicone antifoam agents SA 2 to 6 were used as the first component in an amount of 15% by weight, that CP3 was used as the second component in an amount of 35% by weight, and that water was used in an amount of 50% by weight.

The antifoam performance of each of the above Samples 9 to 14 was tested in the same manner as that of Sample 1 in Example 1 using foamable liquid A. The results are shown in the following Table V.

TABLE V

| | | | Sample | Sample | Sample | Sample | Sample | Sample |
|---|---|---|---|---|---|---|---|---|
| | | | 9 | 10 | 11 | 12 | 13 | 14 |
| Recipe | Type | | SA1 | SA2 | SA3 | SA4 | SA5 | SA6 |
| of | Amount | | 15 | 15 | 15 | 15 | 15 | 15 |
| Comp. | CP3 | | 35 | 35 | 35 | 35 | 35 | 35 |
| (wt %) | water | | 50 | 50 | 50 | 50 | 50 | 50 |
| Antifoam | Time | 0 | 230 | 230 | 230 | 230 | 230 | 230 |
| Perform. | (min.) | 0.5 | 50 | 70 | 40 | 75 | 50 | 50 |
| Foam Vol | | 1.0 | 25 | 85 | 50 | 80 | 65 | 70 |
| (ml) | | 3.0 | 75 | 125 | 85 | 110 | 120 | 115 |

### Example 4

Foam control compositions, hereinafter referred to as Samples 15 to 18, were prepared in the same manner as that of Example 1, except that different silicone antifoam agents (SA 8 to 11) were used as the first component in an amount of 15% by weight, that CP8 was used as the second component in an amount of 35% by weight, and that water was used in an amount of 50% by weight.

Each of the compositions produced as hereinabove described was diluted in accordance with the following recipe: 0.5 g of the emulsion was added to 49.5 g of de-ionized water; 1 g of the previous dilution was then added to 99 g of a 1 wt % solution of Triton X-100 in an 8 oz square bottle to make a foaming composition with a total of 50 ppm of component 1 and 2. The foaming composition was shaken for 10 seconds by a barrel wrist action shaker. The time t (seconds) between the discontinuance of shaking and the drop in foam to 5 mm and the time T (seconds) between the discontinuance of shaking and the appearance of the liquid surface were measured. The bottle was shaken again for 40 seconds and the times were likewise measured. The test was further continued by increasing the shaking time to 60, 120, and 600 seconds. The results are shown below in Table VI.

TABLE VI

| | | Sample 15 | | Sample 16 | | Sample 17 | | Sample 18 | |
|---|---|---|---|---|---|---|---|---|---|
| Recipe of | 1st | SA 8 | | SA 9 | | SA 10 | | SA 11 | |
| Antifoam | Comp. | 35 | | 35 | | 35 | | 35 | |
| Composit- | 2nd | CP8 | | CP8 | | CP8 | | CP8 | |
| ion | Comp. | 15 | | 15 | | 15 | | 15 | |
| (wt %) | Water | 50 | | 50 | | 50 | | 50 | |
| Shake Time (sec) | | t | T | t | T | t | T | t | T |
| 50 ppm | 10 | 58 | >120 | 27 | 32 | 43 | >120 | 58 | >120 |
| t = | 40 | 82 | >120 | 42 | 52 | 24 | 32 | 168 | >120 |
| Collapse | 60 | 110 | >120 | 53 | 70 | 25 | 31 | 195 | >120 |
| T = | 120 | 110 | >120 | 65 | 110 | 30 | 36 | 235 | >120 |
| Break | 600 | 87 | >120 | 37 | 43 | 43 | 54 | 220 | >120 |

In order to test the dispersion stability, the samples were allowed to stand still at 25° C. As a result, it was confirmed that, even after the lapse of 1 month, the same stable dispersion condition as that initially observed was maintained with respect to coalescence and aggregation, both for the foam control compositions and the first dilutions in de-ionized water. By comparison, samples made in the same manner as examples 15-18, except that second component, CP8, was replaced with a silicone glycol copolymer with the same characteristics as CP8 without the siloxane bridge, were stable less than 48 hours.

### Example 5

Samples 19 through 24 were prepared by adding Component I, the silicone antifoam agent, to the diluent then adding Component II, the cross-linked polymer, with mixing. The individual components and their amounts for each sample is listed below in Table VII.

TABLE VII

| | | | | | Sample |
|---|---|---|---|---|---|
| Sample 19 | Sample 20 | Sample 21 | Sample 22 | Sample 23 | 24 |
| SA 7 | SA 7 | SA 1 | SA 1 | SA 1 | SA 1 |
| 40.3 | 39.9 | 39.9 | 34.0 | 39.9 | 39.6 |
| CP 3 | CP 3 | CP 3 | CP 3 | CP 8 | CP 8 |
| 4.2 | 0.2 | 0.3 | 1.0 | 0.2 | 1.0 |
| P15-200 | P15-200 | Ucon 260 | Ucon 5100 | L101 | L101 |
| 55.5 | 59.9 | 59.8 | 65.0 | 59.9 | 59.4 |

In order to test the dispersion stability, the samples were allowed to stand still at 25° C. As a result, it was confirmed that, even after the lapse of a month, the same stable dispersions as that initially observed were maintained.

Sample 23 and 24 were further diluted with water to a total of 15 wt % of Component I and II. These dilutions were also stable for greater than 1 week. Sample 22 was diluted several times with water to make various emulsions which include a total of 12 wt % water, 41 wt % water and 71 wt % water. These dilutions were stable for more than a week.

### Example 6

Samples 19 and 20 from above were also diluted to 0.1 wt % of the total sample into a concentrated liquid detergent. This highly concentrated heavy duty liquid detergent containing from 10 to about 24 wt % water has been described, for example, by Kennedy in U.S. Pat. No. 4,973,416.

The samples were allowed to stand still at 25° C. The silicone antifoam agent remained dispersed for at least one week.

Sample 19 was further tested in a washing machine test. The general procedure may be found in Hill et al. at Col. 14, line 20-Col. 15, line 3 of U.S. Pat. No. 5,262,088. The procedure was modified to use the 0.1 wt % dilution previously described above. 131 g of this detergent/antifoam combination was added in place of the combination described by Hill et al. At 12 minutes the average foam height was 5.6 cm. Without an antifoam present, the foam typically comes out of the top of the machine before 4 minutes.

That which is claimed is:

1. A foam control composition comprising:
(I) a silicone antifoam agent wherein the silicone antifoam agent is a reaction product prepared by reacting at a temperature of 50° C. to 300° C.:
(i) 100 parts by weight of at least one polyorganosiloxane selected from the\ group consisting of
(A) a polyorganosiloxane having a viscosity of about 20 to 100,000 mm²/s at 25° C. and being expressed by the general formula R²ₐSiO_{(4-a)/2} in which R² is a monovalent hydrocarbon or halogenated hydrocarbon group having 1 to 10 carbon atoms and a has an average value of 1.9 to 2.2 and
(B) a polyorganosiloxane having a viscosity of 200 to about 100 million mm²/s at 25° C. expressed by the general formula R³_{b}(R⁴O)_{c}SiO_{(4-b-c)/2} in which R³ is a monovalent hydrocarbon or halogenated hydrocarbon group having 1 to 10 carbon atoms, R⁴ is hydrogen or a monovalent hydrocarbon group having 1 to 10 carbon atoms, b has an average value of 1.9 to 2.2 and c has a sufficiently large value to give at least one —OR⁴ group in each molecule, at least one such —OR⁴ group being present at the end of the molecular chain;
(ii) 0.5 to 20 parts by weight of at least one resinous silicon compound selected from the group consisting of
(a) an organosilicon compound of the general formula R⁵_{d}SiX_{4-d} in which R⁵ is a monovalent hydrocarbon group having 1 to 5 carbon atoms, X is a hydrolyzable group and d has an average value of one or less,
(b) a partially hydrolyzed condensate of said compound (a),
(c) a siloxane resin consisting essentially of (CH₃)₃SiO_{1/2} units and SiO_{4/2} units wherein the ratio of (CH₃)₃SiO_{1/2} units to SiO_{4/2} units is 0.4:1 to 1.2:1, and
(d) a condensate of said compound (c) with said compound (a) or (b);
(iii) up to 30 parts by weight of a finely divided filler; and
(iv) a catalytic amount of a compound for promoting the reaction of components (i) to (iii); and
(II) a cross-linked organopolysiloxane polymer having at least one polyoxyalkylene group.

2. A composition according to claim 1, wherein (I) further comprises from about 20 to 200 parts by weight for each 100 parts by weight of said reaction product of a silicone-glycol copolymer having its formula selected from 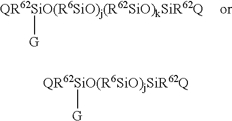
wherein R⁶ is a monovalent hydrocarbon or halogenated hydrocarbon group, Q is R⁶ or G, j has a value of 1 to 150, k has a value of 1 to 400 and G is a polyoxyalkylene group having its formula selected from the group consisting of 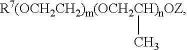
R⁷(OCH₂CH₂)ₘOZ, and 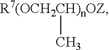
wherein R⁷ is a divalent hydrocarbon group having 1 to 20 carbon atoms, m has an average value of about 1 to 50, n has an average value of 1 to about 50 and Z is selected from the group consisting of hydrogen, an alkyl radical having 1 to 6 carbon atoms and an acyl group having 2 to 6 carbon atoms.

3. A composition according to claim 1, wherein (II) is a compound having a viscosity of 100 to 100,000 mm²/s at 25° C. and having the unit formula: 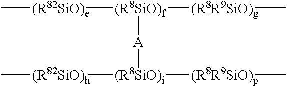
wherein R⁸ is a monovalent hydrocarbon group, A is a group having its formula selected from (CH₂)_{q}—(R¹⁰₂SiO)ᵣSi(CH₂)ₛ or O(R¹⁰₂SiO)ᵣ—SiO wherein R¹⁰ denotes a monovalent hydrocarbon group, q has a value of 2 to 10, r has a value of 1 to 5000, s has a value of 2 to 10, R⁹ denotes a group having its formula selected from the group consisting of: 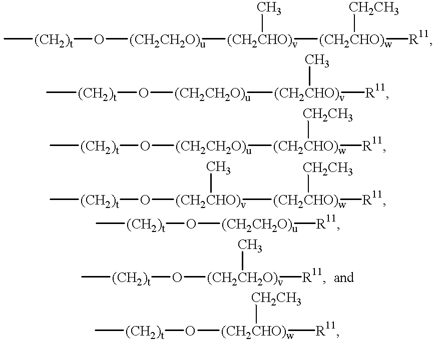
wherein R¹¹ is selected from a hydrogen atom, an alkyl group, an aryl group, or an acyl group, t has a value of 0 to 6, u has a value of from greater than zero to 150, v has a value of from greater than zero to 150, and w has a value of from greater than zero to 150, e has a value of 1 to 1000, f has a value of from greater than zero to 30, g has a value of 1 to 1000, h has a value of 1 to 1000, i has a value of from greater than zero to 30, p has a value of I to 1000.

4. A composition according to claim 1, wherein (II) is a compound having the formula: 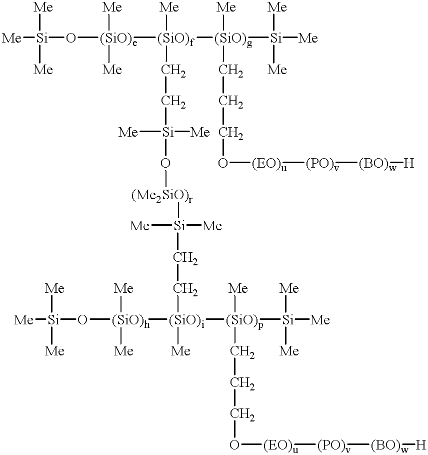
wherein Me denotes methyl, EO denotes ethylene oxide, PO denotes propylene oxide, BO denotes butylene oxide, e has a value of 1 to 1000, f has a value of from greater than zero to 30, g has a value of 1 to 1000, h has a value of 1 to 1000, i has a value of from greater than zero to 30, p has a value of 1 to 1000, r has a value of 1 to 5000, u has a value of 0 to 150, v has a value of 0 to 150, and w has a value of 0 to 150, with the proviso that the value of u+v+w is at least one.

5. A composition according to claim 1, wherein the composition further comprises a compound selected from the group consisting of inorganic fillers, biocides, metal hydroxides, calcium hydroxides, magnesium hydroxides, bis amides, flake-form fillers, dimethylpolysiloxanes, epoxy-functional diorganopolysiloxanes, amino-functional diorganopolysiloxanes, pigments, corrosion inhibitors, and dyes.

6. A composition according to claim 1, wherein the composition further comprises a liquid continuous phase selected from the group consisting of water, ethylene glycol, propylene glycol, polypropylene glycol, polyethylene glycol, copolymers of ethylene and propylene glycols, condensates of polypropylene glycol with polyols, condensates of polyethylene glycol with polyols, condensates of copolymers of ethylene and propylene glycols with polyols, alcohol alkoxylates, alkylphenol alkoxylates, and mixtures thereof.

7. A foam control composition comprising:
(I) a silicone antifoam agent wherein the silicone antifoam agent is a reaction product prepared by reacting at a temperature of 50° C. to 300° C.:
(i) 100 parts by weight of at least one polyorganosiloxane selected from the\ group consisting of
(A) a polyorganosiloxane having a viscosity of about 20 to 100,000 mm²/s at 25° C. and being expressed by the general formula R²ₐSiO_{(4-a)/2} in which R² is a monovalent hydrocarbon or halogenated hydrocarbon group having 1 to 10 carbon atoms and a has an average value of 1.9 to 2.2 and
(B) a polyorganosiloxane having a viscosity of 200 to about 100 million mm²/s at 25° C. expressed by the general formula R³_{b}(R⁴O)_{c}SiO_{(4-b-c)/2} in which R³ is a monovalent hydrocarbon or halogenated hydrocarbon group having 1 to 10 carbon atoms, R⁴ is hydrogen or a monovalent hydrocarbon group having 1 to 10 carbon atoms, b has an average value of 1.9 to 2.2 and c has a sufficiently large value to give at least one —OR⁴ group in each molecule, at least one such —OR⁴ group being present at the end of the molecular chain;
(ii) 0.5 to 20 parts by weight of at least one resinous silicon compound selected from the group consisting of
(a) an organosilicon compound of the general formula R⁵_{d}SiX_{4-d} in which R⁵ is a monovalent hydrocarbon group having 1 to 5 carbon atoms, X is a hydrolyzable group and d has an average value of one or less,
(b) a partially hydrolyzed condensate of said compound (a),
(c) a siloxane resin consisting essentially of (CH₃)₃SiO_{1/2} units and SiO_{4/2} units wherein the ratio of (CH₃)₃SiO_{1/2} units to SiO_{4/2} units is 0.4:1 to 1.2:1, and
(d) a condensate of said compound (c) with said compound (a) or (b);
(iii) up to 30 parts by weight of a finely divided filler; and
(iv) a catalytic amount of a compound for promoting the reaction of components (i) to (iii); and
(II) a cross-linked organopolysiloxane polymer having at least one polyoxyalkylene group prepared by:
(a) heating a mixture of:
(i) a linear polysiloxane having hydrogen atoms in its side chains;
(ii) a polysiloxane having vinyl groups; and
(iii) a catalyst;
(b) adding to the mixture of (a) a mixture of a polyoxyalkylene compound and a solvent; and
(c) stripping the mixture of (b).

8. A composition according to claim 7, wherein (i) is a polysiloxane having the formula 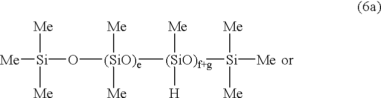
wherein Me denotes methyl, e has a value of from 1 to 1000, and the value of f+g ranges from 1 to 50.

9. A composition according to claim 8, wherein (ii) is a polysiloxane having the formula 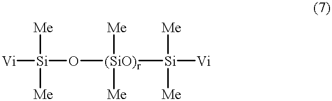
wherein Me denotes methyl, Vi denotes vinyl, and r has a value of from 1 to 5000.

10. A composition according to claim 9, wherein (iii) is a platinum catalyst.

11. A composition according to claim 10, wherein the polyoxyalkylene compound is a compound having its formula selected from the group consisting of:
Vi—CH₂—O—(EO)ᵤ—(PO)ᵥ—(BO)_{w}—H
Vi—CH₂—O—(EO)ᵤ—(PO)ᵥ—H,
Vi—CH₂—O—(EO)ᵤ—(BO)_{w}—H,
Vi—CH₂—O—(PO)ᵥ—(BO)_{w}—H,
Vi—CH₂—O—(EO)ᵤ—H,
Vi—CH₂—O—(BO)_{w}—H, and
Vi—CH₂—O—(PO)ᵥ—H,
wherein Vi denotes vinyl, EO, PO, and BO denote ethylene oxide, propylene oxide, and butylene oxide groups, respectively, u has a value of from 1 to 150, v has a value of 1 to 150, and w has a value of 1 to 150.

12. A composition according to claim 11, wherein the solvent is isopropanol.

13. A process of controlling foam, which includes the addition of an antifoam composition to a foaming medium, the improvement comprising adding the composition of claim 1 to said foaming medium.

14. A process of controlling foam, which includes the addition of an antifoam composition to a foaming medium, the improvement comprising adding the composition of claim 4 to said foaming medium.

15. A process of controlling foam, which includes the addition of an antifoam composition to a foaming medium, the improvement comprising adding the composition of claim 6 to said foaming medium.

16. A process of controlling foam, which includes the addition of an antifoam composition to a foaming medium, the improvement comprising adding the composition of claim 7 to said foaming medium.

17. A process of controlling foam, which includes the addition of an antifoam composition to a foaming medium, the improvement comprising adding the composition of claim 11 to said foaming medium.

18. A process of controlling foam, which includes the addition of an antifoam composition to a foaming medium, the improvement comprising adding the composition of claim 12 to said foaming medium.

19. A method of using a foam control composition comprising adding the foam control composition to a detergent composition comprising at least one surfactant, the improvement comprising adding the composition of claim 1 to said detergent.

20. A method of using a foam control composition comprising adding the foam control composition to a detergent composition comprising at least one surfactant, the improvement comprising adding the composition of claim 7 to said detergent.
